(19) United States
(12) Patent Application Publication
(10) Pub. No.: US 2004/0005533 A1
(43) Pub. Date: Jan. 8, 2004

(54) Teaching method and kit for the dictionary

(76) Inventor: Tomas Reyes, Pico Riviera, CA (US)

Correspondence Address: James Bame, 6419 Seabryn Drive, Rancho Palos Verdes, CA, 90275, US

(21) Appl. No.: 10/190,008

(22) Filed: Jul. 8, 2002

(51) Int. Cl. G09B 17/00

(52) U.S. Cl. 434/178

(57) ABSTRACT

A teaching method for the dictionary comprises the following steps; 1) assembling a binder with a plurality of pages and 2) writing a first set of a plurality of words beginning with the letter ‘A’ onto a first page of the binder. 3) Spelling the plurality of words beginning with the letter ‘A’. 4) Defining the plurality of words beginning with the letter ‘A’. 5) Using the plurality of words beginning with the letter ‘A’ in complete sentences. 6) Pronouncing the plurality of words beginning with the letter ‘A’.

### BACKGROUND

The field of invention relates to teaching methods. In particular, the area of teaching methods for learning the writing, spelling and pronunciation of words in the English language.

The technique is especially applicable to students where English is their second language. The step of pronunciation is key for students who are learning English after primarily using a different language in their early developmental years.

Many children are taught to read before they have learned and developed the mechanics of reading. The illiteracy problem in America has grown at an alarming rate and we need to do something about it right away. It's really a shame that the most powerful and sophisticated Nation in the world cannot fix this problem. Illiteracy keeps growing at an alarming rate and the monies pumped into fixing this are staggering.

Picture yourself waking up one morning in some remote area of the world. The language is foreign to you. Your ability to communicate and express yourself is severely limited. One of the worst feelings in this world is to be deprived of your ability to communicate with other people. Can you imagine being unable to read, write, or speak. Furthermore, you cannot understand what others are attempting to communicate to you.

Many individuals, including the inventor, have entered this country speaking only one language, Spanish. They know what it's like to wake up in a foreign land. They know from personal experience what it feels like to be misplaced and misunderstood. Reading the English language is especially challenging when a person cannot speak English. They attempt to hide their lack of education. If the cycle is not corrected then future generations of children will continue to struggle in reading, with the associated burdens inflicted upon the social and economic development of our country.

This shocking epidemic is spreading. An article by Robert W. Sweet, Jr.', “Illiteracy: An Incurable Disease or Education Malpractice?” written in 1996 for The National Right to Read Foundation describes some of the grim statistics. Over 42 million Americans can't read and over 50 million can only recognize a few printed words limiting them to a 4th to 5^{th} grade reading level. This number includes over 1 million children who drop out of high school, over 400,000 legal immigrants, 100,000 refuges, and 800,000 illegal immigrants and 20% of all high school graduates. More than half the Fortune 500 company's have become educators and it runs over 300 million dollars a year. The cost in welfare programs and unemployment compensation due to illiteracy is a staggering 6 billion dollars a year. The Federal program has more than 79 illiteracy related programs administered by 14 Federal agencies.

Robert W. Sweet, Jr.'s article, goes on to write about Roger Flesch who is the author of “Why Johnny can't read.” Roger Flesch wrote a letter to his daughter about teaching his grandson to read in 1955. He said, “What I found is absolutely fantastic. The teaching of reading all over the United States, is totally wrong and flies in the face of logic and common sense. Johnny couldn't read until half a year ago for the simple reason that nobody ever showed him how.” For many years we have engaged in a form of educational malpractice. The teaching of reading has evolved slowly over the decades, with many of the techniques of teaching remaining basically the same as they were implemented decades ago. Therefore, there is a need for new and innovative techniques for the teaching of grammar skills to our children.

There are two methods to reading. The first is called the “Whole language” or “look and say.” The “look and say” method is done by sight, repetitive memorization and even guessing after learning the mechanics of syllables. The second is “systematic phonics” that teaches children to sound out the words in the first 3 years of Elementary school. By an overwhelming margin the phonics method works much better. Robert W. Sweet's remedy to this is, “The inescapable conclusion is to teach intensive systematic phonics!”

The inventor's own children struggled in reading. They were taught the “look and say” method, instead of phonics from the very beginning. The phonics method is known and is a significant step in the evolution of teaching. Teaching can be taken one step further after the phonics method. Children can be taught phonics up to 3rd grade, but then in the 4^{th} grade, schools can start teaching them the entire dictionary the same way we teach math, by different levels or teach one letter a day, one page a day until you finish the entire dictionary.

Therefore there is a need for an effective teaching method for learning the dictionary. The teaching method should acknowledge and adjust for the particular requirements of students who are learning English as a second language. The teaching method should emphasize correct pronunciation and usage of words.

### SUMMARY

An objective of the teaching method for the dictionary is utilizing the complementary activities of writing, spelling, defining, using in sentences, and pronouncing the words to learn words from the dictionary.

Another objective of the teaching method for the dictionary is developing a comprehension of the correct usage of the word.

Another objective is building a proper base of pronunciation and usage for the student to learn English as a second language. The teaching method can develop the foundation for properly learning the English language.

A teaching method for the dictionary comprises the following steps; first assembling a binder with a plurality of pages, secondly writing a first set of a plurality of words beginning with the letter ‘A’ onto a first page of the binder. Thirdly, spelling the plurality of words beginning with the letter ‘A’. Fourthly, defining the plurality of words beginning with the letter ‘A’. Fifthly, using the plurality of words beginning with the letter ‘A’ in complete sentences.

Sixthly, pronouncing the plurality of words beginning with the letter ‘A’. Repetitive pronunciation will reinforce the correct pronunciation. Developing accurate pronunciation is especially difficult for students who have grown-up speaking a non-English language in the home environment. Early development of correct pronunciation creates the foundation for learning in all future grades.

The student can focus the first day on just words beginning with the letter ‘A’. About ten to twenty-five words can be completed each day by a typical grade school student. Concentrating each day on just words beginning with a specific letter assists the student in learning pronunciation related to that particular letter of the alphabet. The complementary activities of writing, spelling, defining, using in sentences, and pronouncing the words will reinforce the learning and retention of the lesson.

Students are often taught to read words before the student has fully developed a comprehension of the correct usage of the word. When English is a second language for the student, building a proper base of pronunciation and usage is especially important in learning the English language. The teaching method can develop the foundation for properly learning the English language.

After the first day of learning the first set of a plurality of words beginning with the letter ‘A’, a second set of words can be introduced that begin with the letter ‘B’. The steps of writing, spelling, defining, using in sentences, and pronouncing the words would be reiterated for the letter ‘B’.

Additional letters of the alphabet can be learned and added to the binder. The binder will consistently fill with more pages of words that have been thoroughly used by the student. All the subsequent letters ‘C’ through ‘Z’ of the alphabet can be added daily to complete the initial pass through the alphabet. A second pass through the entire alphabet will increase the volume of words learned.

Although the present invention is briefly summarized, a fuller understanding of the invention can be obtained from the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a side view of a binder.

FIG. 2 is a top view of pages.

FIG. 3 is a front view of the computer.

### DETAILED DESCRIPTION OF THE PREFERRED EMBODIMENTS

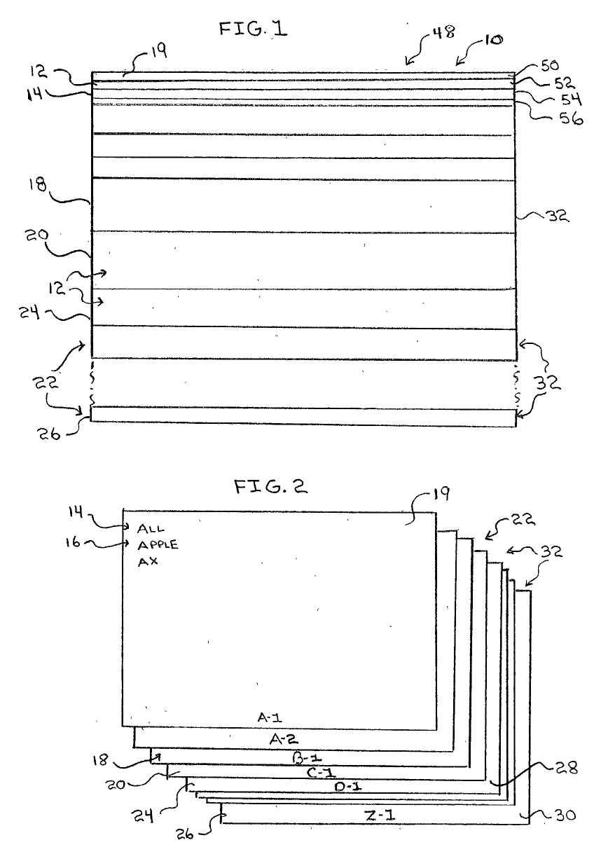

Referring to FIGS. 1 and 2, a teaching method for the dictionary comprises the following steps; 1) assembling a binder 10 with a plurality of pages 12 and 2) writing a first set 14 of a plurality of words 16 beginning with the letter ‘A’ onto a first page 19 of the binder 10. 3) Spelling the plurality of words 16 beginning with the letter ‘A’. 4) Defining the plurality of words 16 beginning with the letter ‘A’. 5) Using the plurality of words 16 beginning with the letter ‘A’ in complete sentences. 6) Pronouncing the plurality of words 16 beginning with the letter ‘A’, which will reinforce the correct pronunciation.

The student can focus the first day on just words beginning with the letter ‘A’. The complementary activities of writing, spelling, defining, using in sentences, and pronouncing the words will reinforce the learning and retention of the lesson.

After the first day of learning the first set 14 of a plurality of words 16 beginning with the letter ‘A’, a second set 18 of words can be introduced that begin with the letter ‘B’. The steps of writing, spelling, defining, using in sentences, and pronouncing the words would be reiterated for the letter ‘B’.

The steps would include the following. Writing a second set 18 of a plurality of words 16 beginning with the letter ‘B’ onto a second page of the binder 10. Spelling the second set 18 of a plurality of words 16 beginning with the letter ‘B’. Defining the plurality of words 16 beginning with the letter ‘B’. Using the plurality of words 16 beginning with the letter ‘B’ in complete sentences. Pronouncing the plurality of words 16 beginning with the letter ‘B’.

Each subsequent day an additional letter of the alphabet can be learned and added to the binder 10. On the third day the lesson will involve writing a third set 20 of a plurality of words 16 beginning with the letter ‘C’ onto a third page of the binder 10. Spelling the third set 20 of a plurality of words 16 beginning with the letter ‘C’. Defining the plurality of words 16 beginning with the letter ‘C’. Using the plurality of words 16 beginning with the letter ‘C’ in complete sentences. Pronouncing the plurality of words 16 beginning with the letter ‘C’.

All the subsequent letters ‘D’ through ‘Z’ of the alphabet can be added day by day to complete the initial pass through the alphabet. The student will be writing a plurality of sets 22, with the sets correspondingly designated a fourth set 24 through a twenty-sixth set 26 for the letters ‘D’ through ‘Z’. Each set thus corresponds to a plurality of words 16 beginning with a unique letter of the alphabet for the letters ‘D’ through ‘Z’. The plurality of sets 22 are arranged in alphabetical sequence onto corresponding numerically sequenced pages 12, which are a fourth page 28 through a twenty-sixth page 30 of the binder 10.

The binder 10 can be divided into twenty-six sections 32 designated ‘A’ to ‘Z’. On the initial pass through the alphabet each section may have a page designation. For example, the first page 19 is correspondingly designated ‘A-1’ through the twenty-sixth page ‘Z-1’. On the second pass through the alphabet each section may have an added page that is numerically a higher designation. The alphabetical character would remain the same to correspond to the unique letter being learned within that section. For example, the added page of section ‘A’ would be designated ‘A-2’. Pages twenty-seven through page fifty-two would be added in the learning developed in the second pass. After the second pass through the alphabet the binder sections 32 would contain the pages ‘A-2’ through ‘Z-2’.

A third pass through the alphabet would add the pages ‘A-3’ through ‘Z-3’ to the corresponding sections 32 ‘A’ to ‘Z’. The third and subsequent passes through the alphabet would continue to build the volume of words learned and comprehended by the student. As the binder 10 is built, the student develops a sense of accomplishment, pride and ownership in the results. The binder 10 becomes the personal notebook of that particular student.

More individualized variations of the learning steps can be included. For example, during the definition step the student can write his/her own definition of the word. A general definition of the word would be given to the whole class initially to provide a basis of comprehension of the correct meaning of the word. A class discussion could be initiated, where the students express their opinion and interpretation of the definition of the word. Following the class discussion, each student would be asked to write in their own words a definition. Their personal definition would be influenced by the general definition, the class discussion and their own perspective and experience.

Different students have varying levels of educational development and personal experience from which to draw upon. Rational thinking capabilities are developed when the student is encouraged to express a personal definition of the word. Learning retention is enhanced because the student has been more interactive in the learning process by using various complementary steps to reinforce the learning process.

A personal sense of accomplishment, pride and ownership in the results of building the notebook binder 10 serves to provide motivation to the student to learn. The learning environment is fun, stimulating and interactive, thereby allowing the child's creative mind to become more involved in the learning process. When the creative portion of the human mind is involved learning may be more comprehensive and the retention rate higher.

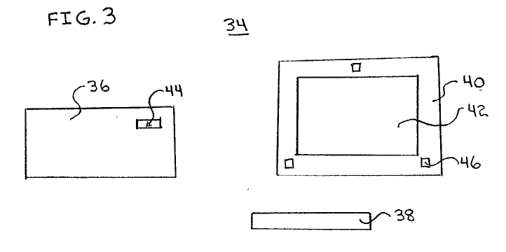

Referring also to FIG. 3, a computer 34 including the computer processor 36, keyboard 38 and computer monitor 40 with a monitor screen 42, can be added and used for some of the steps of the teaching method. The keyboard 38 or other input device is used to type the information into the computer 34 for presentation on the computer monitor 40, rather than writing these steps on a page of paper. The steps can include 1) turning on and initiating a computer 34. 2) typing a first set 14 of a plurality of words 16 beginning with the letter ‘A’ onto a first page 19 of the computer monitor 40 in conjunction with the computer 34. 3) The step of spelling the plurality of words 16 beginning with the letter ‘A’ can be performed verbally or performed in conjunction with the computer 34 through the use of Speech Recognition Software 44. 4) Defining the plurality of words 16 beginning with the letter ‘A’, by typing the definition into the computer 34 and onto the first page 19 of the computer monitor 40. 5) Using the plurality of words 16 beginning with the letter ‘A’ in complete sentences, by typing the sentences into the computer 34 and onto the first page 19 of the computer monitor 40. 6) Pronouncing the plurality of words 16 beginning with the letter ‘A’, which will reinforce the correct pronunciation. Once again, similar to the step of spelling, the step of pronouncing can be performed verbally or performed in conjunction with the computer 34 through the use of Speech Recognition Software 44.

After utilizing the computer 34 and monitor screen 42 to learn the first set 14 of a plurality of words 16 beginning with the letter ‘A’, a second set 18 of words can be introduced that begin with the letter ‘B’. Through the computer 34 and monitor screen 42 the steps of writing, spelling, defining, using in sentences, and pronouncing the words would be reiterated for the letter ‘B’.

The steps would include the following. Typing a second set 18 of a plurality of words 16 beginning with the letter ‘B’ onto a second page of the monitor screen 42. Spelling the second set 18 of a plurality of words 16 beginning with the letter ‘B’. Defining the plurality of words 16 beginning with the letter ‘B’. Using the plurality of words 16 beginning with the letter ‘B’ in complete sentences. Pronouncing the plurality of words 16 beginning with the letter ‘B’. Similarly, the computer can be used for the above mentioned steps that relate to the letters ‘C’ through ‘Z’.

Speech recognition software 44 in conjunction with a microphone 44 is very applicable to the steps of spelling and pronouncing. Speech recognition Software 44 continues to develop in capability and user friendliness. Early versions of speech recognition Software 44 were prone to errors and required proof reading and editing by a person. Current speech recognition Software 44 products available in the marketplace are well advanced in capability and have significantly reduced the rate of errors. It is important that the speech recognition Software 44 be accurate, so any errors can be attributed to the student's own incorrect spelling and is not the result of a computer error in misinterpreting the letter that the student has spoken.

High speech discernment and low error rate by the computer 34 is critical in the step of pronouncing. The student that is just learning English is prone to incorporating an accent into their speech pattern. This accent creates an additional challenge to the overall accuracy of the Software 44. The Software 44 must be able to distinguish the English word that is being spoken. It is an additional benefit, if the Software 44 also has the ability to analyze whether the student has correctly pronounced the word without excessive accent. Students developing English as a second language will dramatically benefit if the Software 44 can include the capability of high accuracy discernment for correct pronunciation. Altered pronunciation can occur due to foreign accents, regional accents, speech slurring and other impediments to clear pronunciation.

Referring again to FIGS. 1 and 2, a kit 48 for learning the teaching method for the dictionary provides an assembled package that conveniently incorporates the required tools and information. The kit 48 includes and primarily consists of the binder 10 having a plurality of sections 32. Each section has a plurality of pages 12 that corresponds to a letter of the alphabet. The sections 32 are in alphabetical sequence from ‘A’ to ‘Z’. The student writes a plurality of words 16 beginning with a specific letter of the alphabet into each section of the binder 10, which corresponds to the letter designation ‘A’ to ‘Z’ of each unique section. Words beginning with the letter ‘A’are written in the ‘A’ section. Words beginning with the letter ‘B’ are written in the ‘B’ section, and so on for the letters ‘C’ through ‘Z’. The twenty six sections 32 designated ‘A’ to ‘Z’ will each having a page correspondingly designated ‘A-1’ to ‘Z-1’.

On the second pass through the alphabet each section of the kit 48 may have an added page that is numerically a higher designation. The alphabetical character would remain the same to correspond to the unique letter being learned within that section 32. After the second pass through the alphabet the kit 48 would contain sections 32 with the pages ‘A-2’ through ‘Z-2’ being completed by the student.

The kit 48 for the teaching method for the dictionary can be subdivided to incorporate a first subsection 50 for verifying the correct spelling of the plurality of words 16 beginning with the letter ‘A’. A second subsection 52 for defining the plurality of words 16 beginning with the letter ‘A’. A third subsection 54 that provides examples of using the plurality of words 16 beginning with the letter ‘A’ in complete sentences. Also, a fourth subsection 56, which provides examples of pronouncing the plurality of words 16 beginning with the letter ‘A’.

Although the present invention has been described in considerable detail with regard to the preferred versions thereof, other versions are possible. Therefore, the appended claims should not be limited to the descriptions of the preferred versions contained herein.

What is claimed is:

1. A teaching method for the dictionary comprising the steps of:
a) writing a first set of a plurality of words beginning with the letter ‘A’;
b) defining the plurality of words beginning with the letter ‘A;
c) using the plurality of words beginning with the letter ‘A’ in complete sentences; and
d) pronouncing the plurality of words beginning with the letter ‘A’, so as to reinforce the correct pronunciation.

2. The teaching method for the dictionary of claim 1, further comprising the step of spelling the plurality of words beginning with the letter ‘A’, upon writing a first set.

3. The teaching method for the dictionary of claim 2, further comprising the step of writing a second set of a plurality of words beginning with the letter ‘B’, upon pronouncing the first set of the plurality of words beginning with the letter ‘A’.

4. The teaching method for the dictionary of claim 3, further comprising the step of defining the second set of a plurality of words beginning with the letter ‘B’, upon writing the second set.

5. The teaching method for the dictionary of claim 4, further comprising the step of writing a plurality of sets, wherein each set corresponds to a plurality of words beginning with a unique letter of the alphabet for the letters ‘C’ through ‘D’, upon defining the second set beginning with the letter ‘B’.

6. A teaching method for the dictionary comprising the steps of:
a) assembling a binder with a plurality of pages;
b) writing a first set of a plurality of words beginning with the letter ‘A’ onto a first page of the binder;
c) spelling the plurality of words beginning with the letter ‘A’;
d) defining the plurality of words beginning with the letter ‘A’;
e) using the plurality of words beginning with the letter ‘A’ in complete sentences;
f) pronouncing the plurality of words beginning with the letter ‘A’, so as to reinforce the correct pronunciation;
g) writing a second set of a plurality of words beginning with the letter ‘B’ onto a second page of the binder;
h) writing a third set of a plurality of words beginning with the letter ‘C’ onto a third page of the binder; and
i) writing a plurality of sets, wherein each set corresponds to a plurality of words beginning with a unique letter of the alphabet for the letters ‘D’ through ‘Z’, wherein the sets are arranged in alphabetical sequence onto corresponding numerically sequenced a fourth page through a twenty-sixth page of the binder.

7. The teaching method of claim 6, wherein the binder having twenty-six sections designated ‘A’ to ‘Z’, wherein each section having the first page correspondingly designated ‘A-1’ through the twenty-sixth page ‘Z-1’.

8. The teaching method of claim 7 further comprising adding an additional page to each of the twenty-six sections designated ‘A’ to ‘Z’, wherein the additional pages are correspondingly designated ‘A-2’ through ‘Z-2’, wherein additional words are added to each of the twenty-six sections, wherein the additional words have a first letter that corresponds to the designations ‘A’ to ‘Z’ of each of the twenty-six sections.

9. The teaching method of claim 1 wherein the step of writing a plurality of words beginning with the letter ‘A’, is accomplished by typing the words onto a monitor screen of a computer.

10. The teaching method for the dictionary of claim 9, wherein the step of defining the plurality of words beginning with the letter ‘A’, is accomplished by typing the definitions onto the monitor screen of the computer.

11. The teaching method for the dictionary of claim 10, wherein the step of using the plurality of words beginning with the letter ‘A’ in complete sentences, is accomplished by typing the sentences onto the monitor screen of the computer.

12. The teaching method for the dictionary of claim 11, further comprising the step of spelling the plurality of words beginning with the letter ‘A’, upon writing the plurality of words.

13. The teaching method for the dictionary of claim 12, wherein the step of pronouncing is accomplished by speaking the pronunciation of the words into a microphone, wherein the microphone is operatively connected to the computer, wherein speech recognition software analyzes the correct pronunciation of the words.

14. The teaching method for the dictionary of claim 13, further comprising the step of typing a second set of a plurality of words beginning with the letter ‘B’ onto the monitor screen of the computer, upon pronouncing the plurality of words beginning with the letter ‘A’.

15. The teaching method for the dictionary of claim 14, further comprising the steps of typing a plurality of sets onto the monitor screen of the computer, wherein each set corresponds to a plurality of words beginning with a unique letter of the alphabet for the letters ‘C’through ‘Z’, upon typing a second set beginning with the letter ‘B’.

16. A kit for a teaching method for the dictionary comprising: a binder having a plurality of sections, each section having a plurality of pages, wherein each section corresponds to a letter of the alphabet, wherein the sections are in alphabetical sequence from ‘A’ to ‘Z’, such that a plurality of words beginning with a specific letter may be written into each section of the binder corresponding to the letter designation ‘A’ to ‘Z’ of each unique section.

17. The kit for the teaching method for the dictionary of claim 16 further comprising a first subsection for verifying the correct spelling of the plurality of words beginning with the letter ‘A’.

18. The kit for the teaching method for the dictionary of claim 17 further comprising a second subsection for defining the plurality of words beginning with the letter ‘A’.

19. The kit for the teaching method for the dictionary of claim 18 further comprising a third subsection, wherein the third subsection provides examples of using the plurality of words beginning with the letter ‘A’ in complete sentences.

20. The kit for the teaching method for the dictionary of claim 19 further comprising a fourth subsection, wherein the fourth subsection provides examples of pronouncing the plurality of words beginning with the letter ‘A’.
